(19) United States
(12) Patent Application Publication
(10) Pub. No.: US 2001/0013043 A1
(43) Pub. Date: Aug. 9, 2001

(54) SYSTEM AND METHOD FOR DETERMINING BROWSER PACKAGE AND VERSION COMPATIBILITY OF A WEB DOCUMENT

(76) Inventor: RICHARD J. WAGNER, FREMONT, CA (US)

Correspondence Address: Darren E. Donnelly, McCutchen, Doyle, Brown & Enersen, Three Embarcadero Center, San Francisco, CA, 94111, US

(21) Appl. No.: 09/041,836

(22) Filed: Mar. 12, 1998

(51) Int. Cl. G06F 15/00

(52) U.S. Cl. 707/511

(57) ABSTRACT

A system determines browser package and version compatibility of a web document by searching a document for computer language keywords. The system comprises keyword memory storing a first set of keywords corresponding to a computer language not executable by a browser package, a search engine coupled to the keyword memory for searching a web document for keywords, and an inspection engine coupled to the search engine for controlling the search engine to search the web document for the first set of keywords. The keywords used for determining browser package compatibility include keywords not executable by the browser package and executable by other browser packages. The keywords used for determining browser version compatibility include keywords specific to a version. Accordingly, the inspection engine may first test for compatibility with the latest version and may work its way downward. Based on the results, the inspection engine can determine with which browser packages and versions a web document is compatible.

### BACKGROUND OF THE INVENTION

1. Field of the Invention

This invention relates generally to web scripts, and more particularly provides a system and method for determining browser package and version compatibility of a web document.

2. Description of the Background Art

Currently, a web developer creates a web document containing Hyper Text Markup Language (HTML) and specific web scripts compatible with the browsers which will execute the web document created. For example, the Netscape Navigator® browser (hereafter referred to as “Netscape”) developed by the Netscape Communications Corporation is configured to execute the JavaScript scripting language developed by Sun Microsystems, Inc., and the Internet Explorer browser (hereinafter referred to as “Explorer”) is configured to execute the JScript scripting language both developed by the Microsoft Corporation. The JavaScript and JScript scripting languages have some operations in common. Accordingly, Explorer can execute some but not all JavaScript operations, and Netscape can execute some but not all JScript operations. Thus, a web document may be compatible with Netscape, may be compatible with Explorer, or may be compatible with both.

After composing the web document, the web developer can run preview copies of different versions of Netscape and Explorer to determine whether the web document is compatible with either browser package or both and to determine which browser versions are needed. If any version of a browser package, e.g. Explorer 3.0, fails during the execution of the web document, then the web developer must examine the code to find the incompatible operation(s). After several iterations, the web developer may have a web document compatible with desired versions of both browser packages. However, performing several iterations is time intensive and requires significant knowledge of the different scripting languages. Accordingly, to facilitate web document production and to provide multi-package versatility, a system and method for determining browser package and version compatibility of a web document are needed.

### SUMMARY OF THE INVENTION

A system determines browser package and version compatibility of a web document by searching a document for computer language keywords. Examples of browser packages include the Netscape Navigator® browser (hereafter referred to as “Netscape”) developed by the Netscape Communications Corporation and the Internet Explorer browser (hereinafter referred to as “Explorer”) developed by the Microsoft Corporation. Examples of browser package versions include, for Netscape, Netscape 1.0, Netscape 2.0, Netscape 3.0 and Netscape 4.0. The system comprises keyword memory storing a first set of keywords corresponding to a computer language not executable by a browser package, a parser coupled to the keyword memory for searching a web document for keywords, and an inspection engine coupled to the parser for controlling the parser to search the web document for the first set of keywords. The keywords used for determining browser package compatibility include keywords not executable by the browser package and executable by other browser packages. The keywords used for determining browser version compatibility include keywords specific to a version. Accordingly, the inspection engine may first test for compatibility with the latest version and may work its way downward. Based on the results, the inspection engine can determine with which browser packages and versions a web document is compatible.

The present invention further provides a method for determining browser package and version compatibility of a web document by searching a document for computer language keywords. The method comprises the steps of receiving an indication of a web document to inspect, receiving an indication of a browser package having a set of versions containing at least one version, retrieving from memory a first set of keywords corresponding to a computer language not executable by the browser package, and determining based on the first set of keywords whether the web document is incompatible with the browser package.

The system and method of the present invention advantageously facilitates the production of browser package and version compatible web documents. The web developer need not perform multiple tests to determine whether each version in each browser package can execute all aspects of a web document. The web developer need not spend endless hours reviewing a web document to locate an operation that is offensive to a particular browser package or to a particular version in a browser package.

### BRIEF DESCRIPTION OF THE DRAWINGS

FIG. 1 is a block diagram illustrating a computer system in accordance with the present invention;

FIG. 2 illustrates an inspection request screen;

FIG. 3 is a block diagram illustrating details of the inspector of FIG. 1;

FIG. 4 is a block diagram illustrating details of the keywords table of FIG. 3;

FIG. 5 is a flowchart illustrating a preferred method for determining browser compatibility of a web document in accordance with the present invention;

FIG. 6a illustrates a first example inspection results screen;

FIG. 6b illustrates a second example inspection results screen; and

FIG. 6c illustrates a third example inspection results screen.

### DETAILED DESCRIPTION OF THE PREFERRED EMBODIMENT

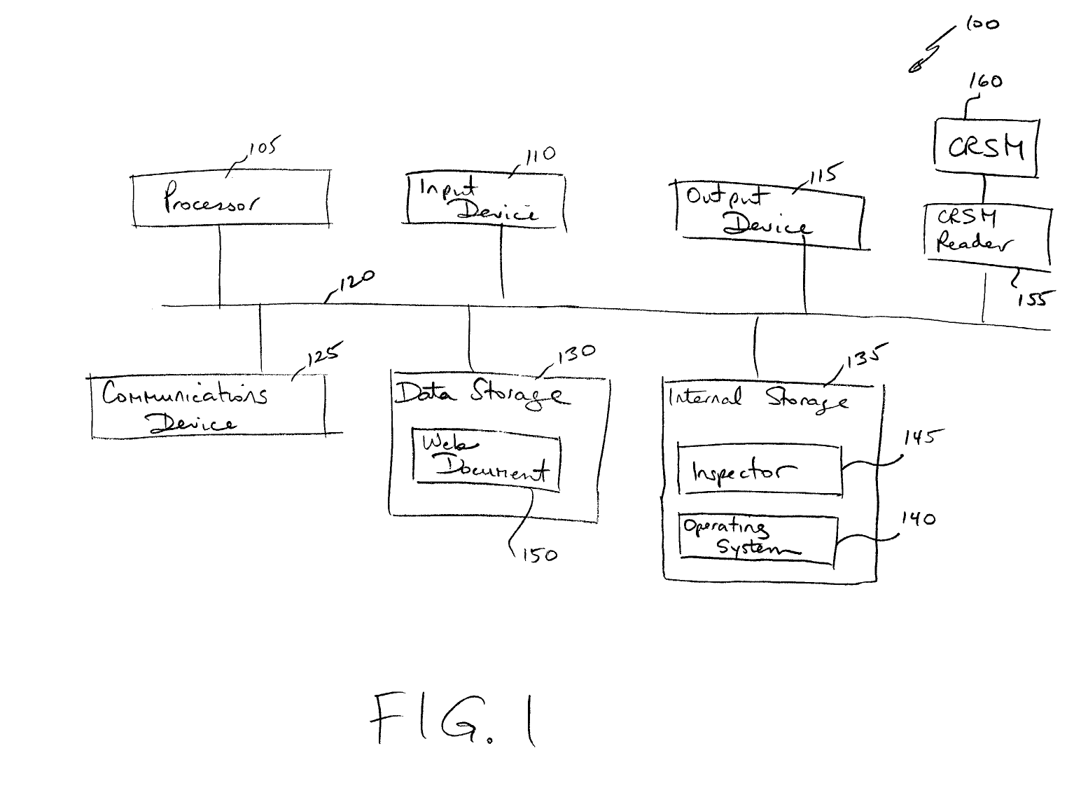

FIG. 1 is a block diagram illustrating a computer system 100 in accordance with the present invention. The computer system 100 includes a processor 105, such as an Intel Pentium® microprocessor or a Motorola Power PC® microprocessor, coupled to a communications channel 120. The computer system 100 further includes an input device 110 such as a keyboard or mouse, an output device 115 such as a Cathode Ray Tube (CRT) display, a communications device 125, data storage 130 such as a magnetic disk, and internal storage 135 such as Random-Access Memory (RAM), each coupled to the communications channel 120. The communications channel 120 may be coupled to a network such as the wide-area network commonly referred to as the Internet. One skilled in the art will recognize that, although the data storage 130 and internal storage 135 are illustrated as integral units, the data storage 130 and internal storage 135 can be distributed units.

An operating system 140 controls processing by the processor 105, and is typically stored in data storage 130 and loaded into internal storage 135 (as illustrated) for execution. An inspector 145 determines browser package and version compatibility of a web document 150, and also may be stored in external storage 130 and loaded into internal storage 135 (as illustrated) for execution by processor 105. The web document 150 may be stored in data storage 130 (as illustrated) and loaded into internal storage 135 for the inspector 145 to examine.

One skilled in the art will recognize that the system 100 may also include additional information, such as network connections, additional memory, additional processors, LANs, input/output lines for transferring information across a hardware channel, the Internet or an intranet, etc. One skilled in the art will also recognize that the programs and data may be received by and stored in the system in alternative ways. For example, a computer-readable storage medium (CRSM) reader 155 such as a magnetic disk drive, hard disk drive, magneto-optical reader, CPU, etc. may be coupled to the signal bus 120 for reading a computer-readable storage medium (CRSM) 160 such as a magnetic disk, a hard disk, a magneto-optical disk, RAM, etc. Accordingly, the system 100 may receive programs and data via the CRSM reader 155.

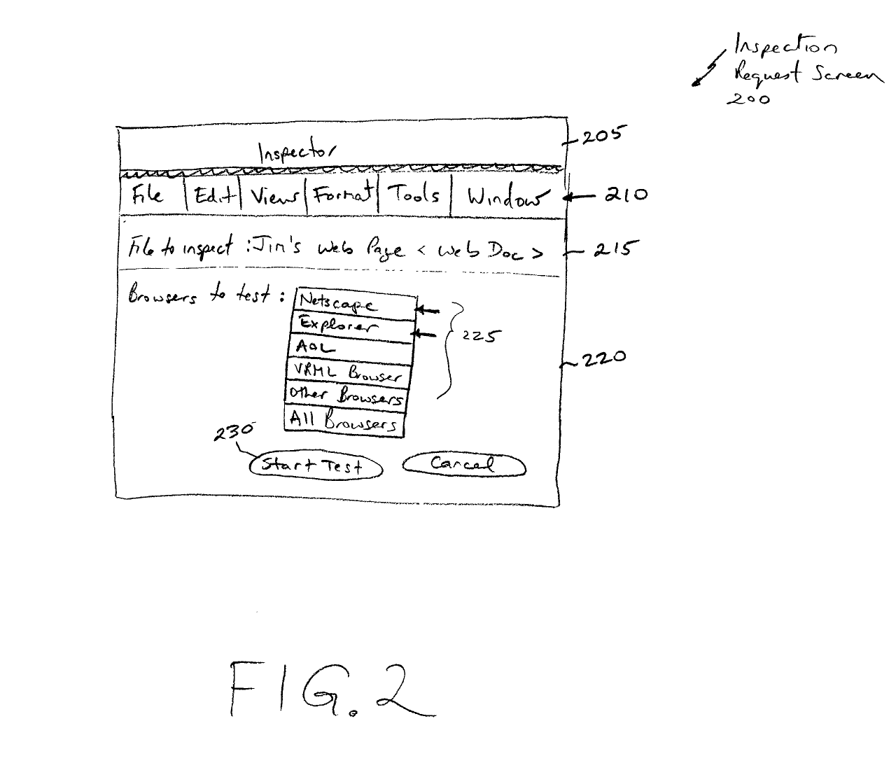

FIG. 2 illustrates a web document inspection request screen 200. The screen 200 includes a header portion 205 labeled for example “Inspector,” a menu portion 210 identifying available menu functions such as file, edit, view, format, tools, window, etc., and a web document portion 215 identifying the web document 205 selected for inspection. In this example, the web document portion 215 identifies “Jim's Web Page” as the file to be inspected by the inspector 145. It will be appreciated that the term “web document” includes any document to be executed by a browser.

The screen 200 further includes a browser selection portion 220, which enables the selection of a browser package 225 from a predetermined set 225 of browser packages 225. A browser package 225 includes a set of at least one browser version. Selecting a browser package 225 via the browser inspection portion 220 instructs the inspector 145 to determine compatibility of the web document 150 with the selected browser package 225 and to determine the minimum version needed (assuming downward compatibility). Examples of browser packages 225 include the Netscape Navigator® browsers (hereafter referred to as “Netscape”) developed by the Netscape Communications Corporation and the Internet Explorer browsers (hereinafter referred to as “Explorer”) developed by the Microsoft Corporation. Other possible browser packages 225 include the America On-line (AOL) browsers, Virtual Reality Modeling Language (VRML) browsers, and the like. The arrows in the browser selection portion 220 depict selected browser packages 225. Depressing the “Start Test” button 225 initiates execution of the inspection of the selected web document 150 by the inspector 145.

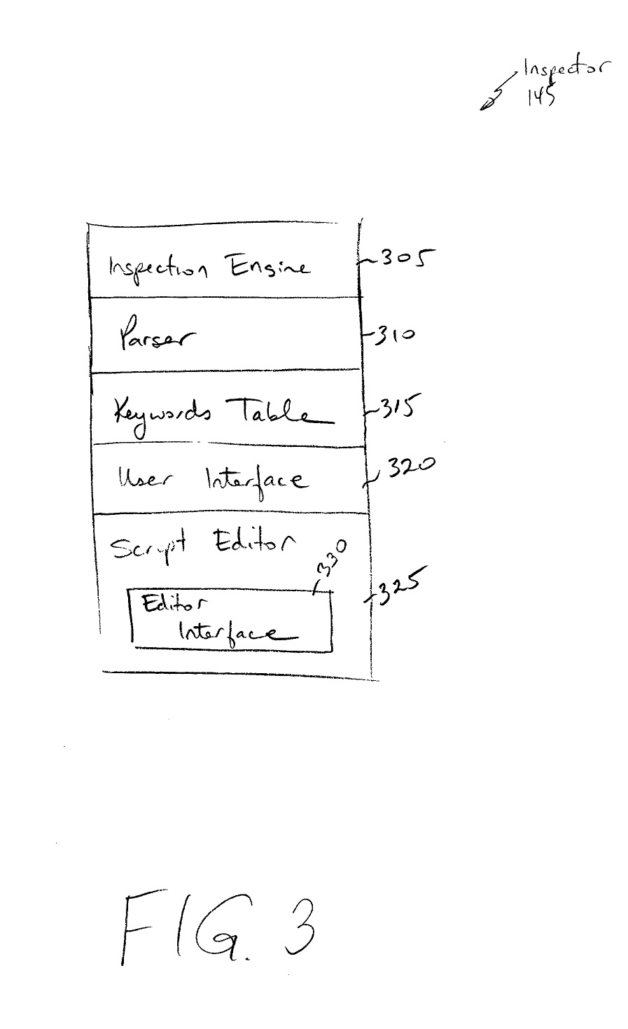

FIG. 3 is a block diagram illustrating details of the inspector 145. The inspector 145 includes an inspection engine 305, a parser 310 (or any type of search engine), a keywords table 315, a user interface 320 and a script editor 325.

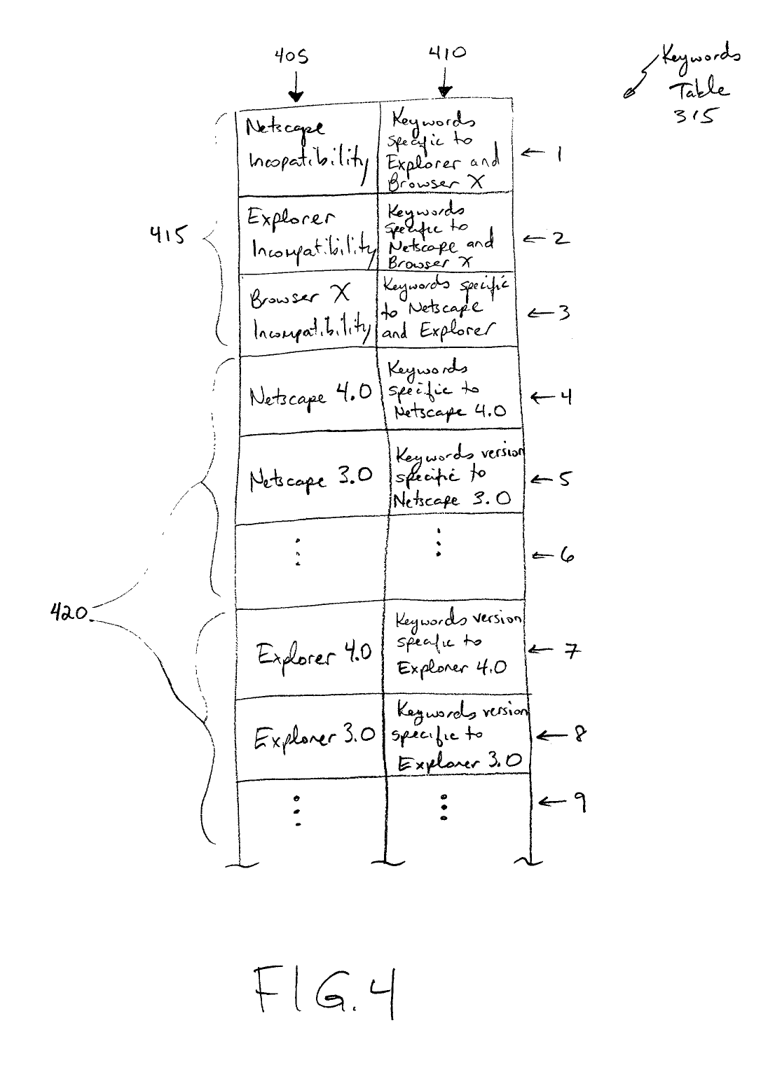

The inspection engine 305 controls the parser 310 and the user interface 320. The inspection engine 305 instructs the user interface 320 to present the inspection request screen 200, and accordingly waits for selection of a web document 150 and at least one web browser package 225. The inspection engine 305 instructs the parser 310 to parse the selected web document 150 for script operations executable by other web browser packages 225 but not executable by the selected web browser package 225. More particularly, the parser 310 parses for keywords corresponding to the non-executable script operations. These keywords are contained in a keywords table 315 as illustrated in FIG. 4. For example, to determine if a web document 150 is compatible with at least one version of Netscape, the inspector 145 determines whether the code includes a script operation dedicated to the other browser packages 225 in the predetermined set 225 such as Explorer. The inspector 145 is initially configured to test for only script operations of a predetermined set of browser packages 225, but may be updated to add, subtract or modify browser packages 225 in the predetermined set 225.

It will be appreciated that the inspection engine 305 determines compatibility accurately only if the selected web document 150 includes script operations corresponding to the predetermined set 225 of browser packages and versions. If the web document 150 includes a script operation dedicated to an unknown browser, then the inspector 145 will determine incorrectly that the web document 150 is compatible with the selected browser package 225. Further, it will be appreciated that the inspection engine 305 does not confirm validity of the script operation. Accordingly, a web developer should perform other tests to confirm script operation validity and should use caution not to include script operations executable only by an obscure browser package which is not included in the predetermined set 225.

After determining that the web document 150 is compatible with at least one version of a selected browser package 225, the inspection engine 305 determines the minimum version of the browser package 225 needed. For example, if the inspection engine 305 determines that the web document 150 does not include a Netscape non-executable script operation, then the inspection engine 305 will determine which version of Netscape is needed to execute the web document 150. The inspection engine 305 instructs the parser 310 to search for keywords corresponding to script operations added to the latest version of Netscape, e.g., Netscape 4.0. If one is found, then the inspection engine 305 concludes that the latest version of Netscape is needed. If one keyword is not found, then the inspection engine 305 instructs the parser 310 to search for keywords corresponding to script operations added to the earlier version of Netscape, e.g., Netscape 3.0. If one keyword is found, then the inspection engine 305 concludes that at least the earlier version of Netscape is needed. The inspection engine 305 continues until it reaches a conclusion. It will be appreciated that, if the versions are not downward compatible, the inspection engine 305 will test all versions.

The inspector 145 also includes a script editor 325 having an editor interface 330. The script editor 325 and editor interface 330 enable the modification of the web document 150. For example, after the inspection engine 305 has performed its compatibility tests and generated a compatibility report, the web developer can use the script editor 325 to modify the script operations that are incompatible with the browser packages or versions desired. The script editor 325 may be a conventional script editor such as that provided by Netscape Navigator Gold®.

FIG. 4 is a block diagram illustrating details of an example keywords table 315. The example keywords table 315 includes a test title column 405 and a keywords column 410. The browser package compatibility rows 415, i.e., in this case the first three rows 415, of the keywords table 315 illustrate the data needed to perform browser package 225 compatibility tests. The version compatibility rows, i.e., in this case the remaining rows 420 (rows 4-9), of the keywords table 315 illustrate the data needed to perform browser version compatibility tests.

The keywords table 315 is configured to manage a predetermined set 225 of three browser packages 225, namely, Netscape, Explorer and Browser X. To determine compatibility of a web document 150 with Netscape, the inspection engine 305 instructs the parser 310 to retrieve from row 1 and parse for keywords dedicated to Explorer and Browser X. These keywords are determined by compiling all keywords corresponding to all operations executable by Explorer and Browser X, and subtracting all common keywords corresponding operations executable by Netscape. Similarly, to determine compatibility of a web document 150 with Explorer, the inspection engine 305 instructs the parser 310 to retrieve from row 2 and parse for keywords dedicated to Netscape and Browser X. To determine compatibility of a web document 150 with Browser X, the inspection engine 305 instructs the parser 310 to retrieve from row 3 and parse for the keywords dedicated to Netscape and Explorer. The keywords of row 2 and row 3 are determined similarly to the keywords of row 1.

Upon recognition of a compatible browser package 225, the inspection engine 305 determines the minimum version needed. The inspection engine 305 instructs the parser 310 to parse for keywords specific to the different versions of the compatible browser package 225. For example, if the inspection engine 305 determines that the web document 150 is Netscape compatible, then the inspection engine 305 instructs the parser 310 to retrieve from row 4 and parse for keywords specific to Netscape 4.0. Keywords specific to Netscape 4.0 are defined as those keywords corresponding to script operations added to Netscape 4.0 after Netscape 3.0 (assuming downward compatibility). If any keywords are located, then the inspection engine 305 determines that Netscape 4.0 (or higher) is needed. Otherwise, the inspection engine instructs the parser 310 to retrieve from row 5 and parse for keywords specific to Netscape 3.0. If any keywords are found, then the inspection engine 305 determines that at least Netscape 3.0 is. Otherwise, the inspection engine 305 instructs the parser 310 to continue with keywords specific to the next earlier version. The inspection engine 305 continues in a similar manner until a minimum version is located for each compatible browser package 225. If the browser packages 225 include versions that are not downwardly compatible, then a technique similar to that used for the different browser packages 225 can be used (i.e., each version can be treated as a browser package 225).

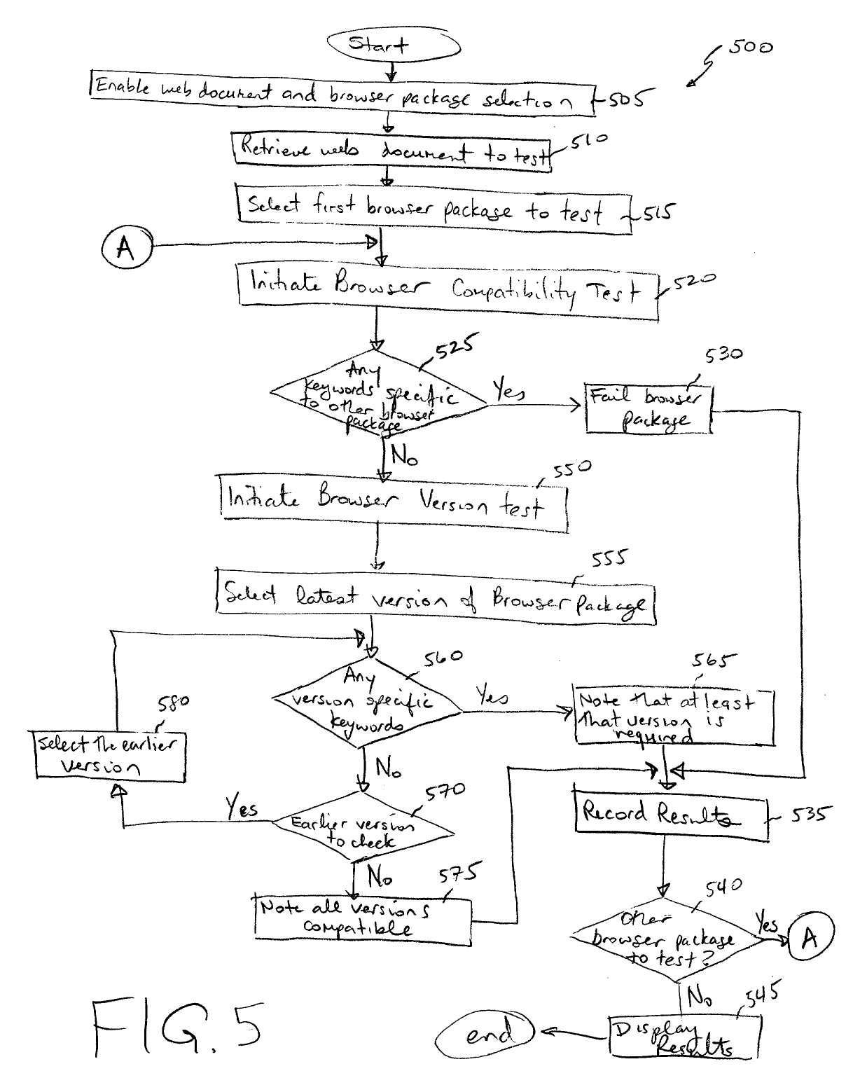

FIG. 5 is a flowchart illustrating a method 500 for determining browser package and version compatibility of a web document 150, in accordance with the present invention. Method 500 begins with the inspection engine in step 505 instructing the user interface 320 to enable web document 150 and browser package 225 selection. The user interface 320 presents an inspection request screen 200, and enables the web developer to select a web document 150 to be inspected and at least one browser package 225 from a predetermined set 225 of browser packages 225 to apply.

The inspection engine 305 instructs the parser 310 in step 510 to retrieve the web document 150 to be inspected from internal storage 130 and in step 515 to select the first of the at least one browser package 225 selected in step 505. The inspection engine 305 in step 520 initiates the browser compatibility test using the currently selected browser package 225. The inspection engine 305 in step 525 instructs the parser 310 to retrieve the keywords from the appropriate browser compatibility row 415 of the keywords table 315 corresponding to the selected package 225, and to parse the selected web document 150 for the retrieved keywords. As stated above, the keywords for the selected row 415 include keywords corresponding to script operations not executable by the selected browser package 225.

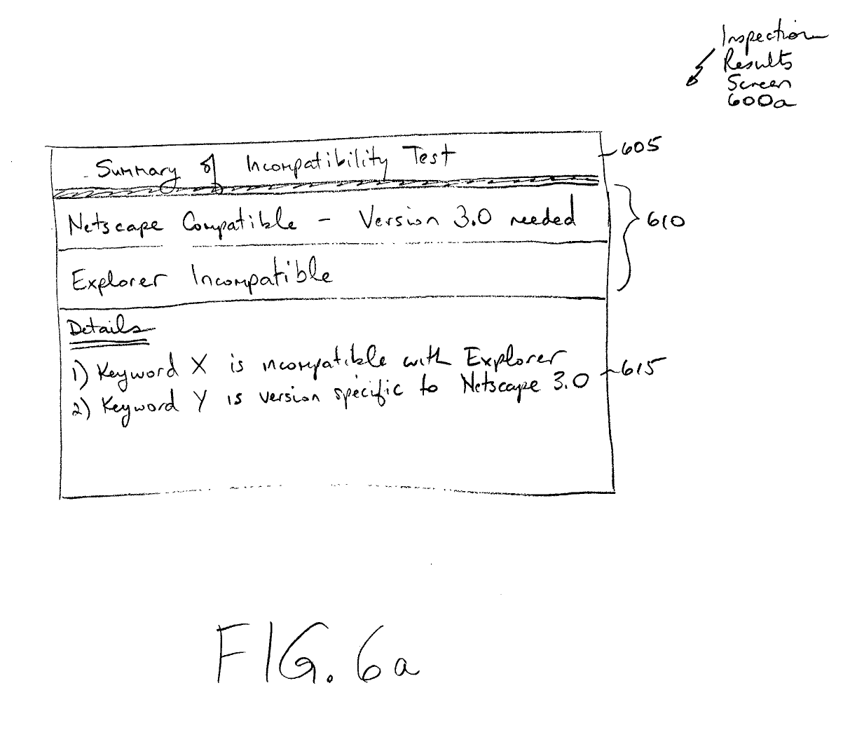

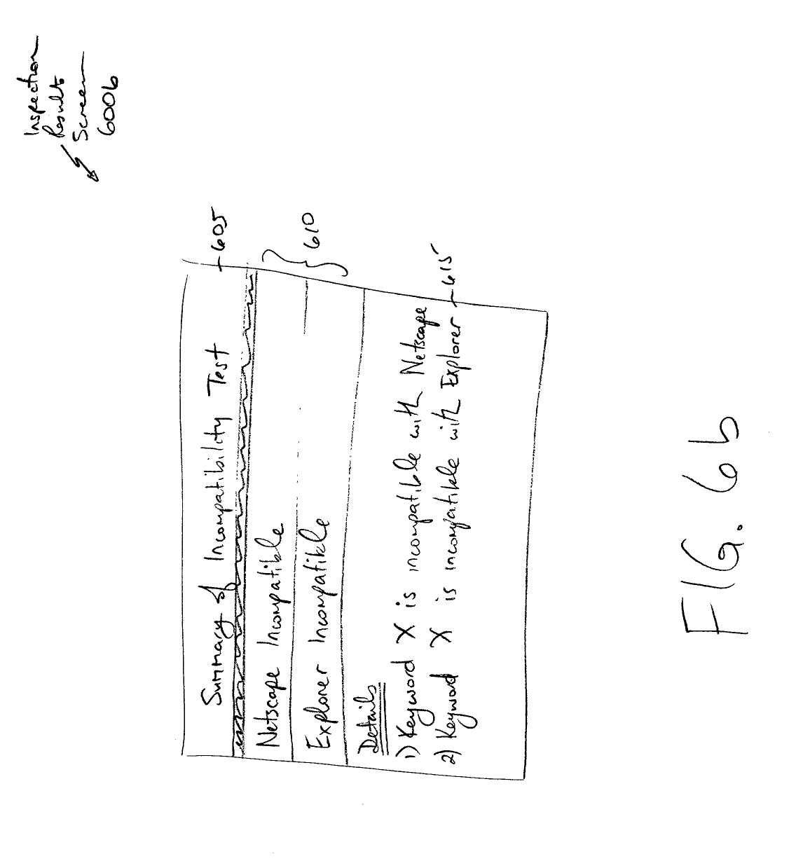

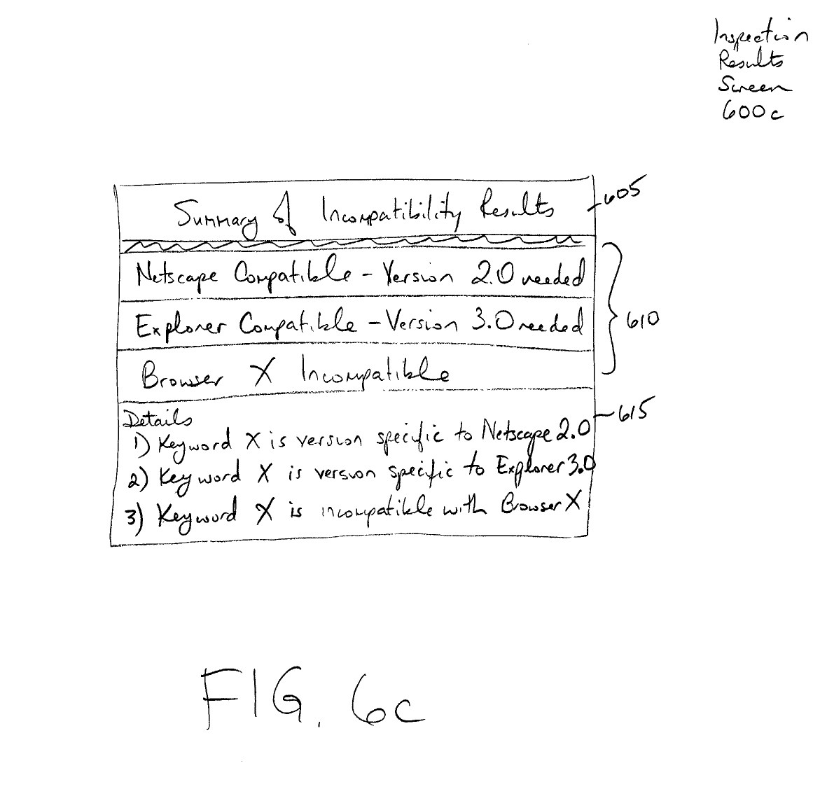

If the parser 310 in step 525 finds one of the corresponding keywords, then the inspection engine 305 in step 530 fails the browser package 225 as incompatible, in step 535 records the results, and in step 540 determines whether another browser package 225 has been selected. If so, then method 500 returns to step 520. Otherwise, the inspection engine 305 in step 545 instructs the user interface 320 to display the results using an inspection results screen 600 (shown in and described with reference to FIGS. 6A-6C). Method 500 then ends.

If the parser 310 in step 525 does not find one of the corresponding keywords, then the inspection engine 305 in step 550 assumes that at least one version of the selected browser package 225 is compatible and accordingly initiates a browser version compatibility test. The inspection engine 305 in step 555 selects the latest version (as defined by the keywords table 315) in the browser package 225. For example, if the selected browser package 225 is Netscape, then according to the keywords table 315 the current latest version is Netscape 4.0. The inspection engine 305 in step 560 instructs the parser 310 to retrieve the keywords from the version compatibility row 420 corresponding to the latest version of the browser package 225 (i.e., row 4), and to parse the web document 150 for the keywords. As stated above, the keywords corresponding to a browser version include the version-specific keywords, i.e., the keywords added since the last earlier version (assuming downward compatibility).

If a version-specific keyword is found, then the inspection engine 315 in step 565 notes that at least that version of the browser package 225 is required. Method 500 then returns to step 535. If the inspection engine 305 does not locate one of the keywords, then the inspection engine 305 in step 570 determines whether there is, according to the keywords table 315, an earlier version to check. If so, then the inspection engine 305 in step 580 selects the next earlier version, and method 500 returns to step 560. Otherwise, the inspection engine 305 in step 575 notes that all versions are compatible, and method 500 returns to step 535.

It will be appreciated that the method 500 assumes downward compatibility of browser packages 225. Accordingly, the version test may be performed starting with the latest version (as described above), or alternatively starting with the earliest version or anywhere in between. It will be further appreciated that, if the assumption of downward compatibility cannot made, then each version of each browser package 225 could be treated as a separate “browser package 225.” Accordingly, no version compatibility inspection would be needed.

FIG. 6a illustrates a first example inspection results screen 600a. The inspection results screen 600a includes a header portion 605, a browser package compatibility portion 610, and a details portion 615. The header portion 605 is labeled for example “Summary of Incompatibility Test.” The browser package compatibility portion 610 indicates that the web document 150 inspected is Netscape compatible and Explorer incompatible (thereby indicating that the browser packages 225 selected included only Netscape and Explorer). The details portion 615 indicates that keyword X in the web document 150 is specific to Netscape, and thus causes the web document 150 to be incompatible with Explorer. The details portion 615 also indicates that keyword Y in the web document 150 is version specific to Netscape 3.0, and thus causes the web document 150 to be incompatible with downwardly compatible versions Netscape 1.0 and Netscape 2.0. It will be appreciated that version specific keyword Y corresponds to an Explorer compatible script operation. Otherwise, keyword Y would have also been labeled as “incompatible with Explorer.”

FIG. 6b illustrates a second example inspection results screen 600b. The inspection results screen 600b includes the header portion 605, the compatibility portion 610 and the details portion 615 as described with reference to FIG. 6a. However, the content in the compatibility portion 610 and in the details portion is different. The compatibility portion 610 indicates that the web document 150 is Netscape and Explorer incompatible (thereby also indicating that the browser packages 225 selected included only Netscape and Explorer). The details portion 615 indicates that the keyword X in web document 150 is incompatible with Netscape and incompatible with Explorer. For example, keyword X may correspond to an operation specific to Browser X.

FIG. 6c illustrates a third example inspection results screen 600c. The inspection results screen 600c includes the header portion 605, the compatibility portion 610 and the details portion 615 as described with reference to FIG. 6a. However, again, the content in the compatibility portion 610 and in the details portion is different. The compatibility portion 610 indicates that the web document 150 is Netscape compatible, Explorer compatible and Browser X incompatible (thereby indicating that the browser packages 225 selected included Netscape, Explorer and Browser X). The compatibility portion 610 further indicates that the Netscape version needed is Netscape 2.0 and the Explorer version needed is Explorer 3.0. The details portion 615 indicates that Keyword X is version specific to Netscape 2.0, is version specific to Explorer 3.0, and is incompatible with Browser X.

The foregoing description of the preferred embodiments of the present invention is by way of example only, and other variations and modifications of the above-described embodiments and methods are possible in light of the foregoing teaching. For example, although the system and method have been described as operating in a downwardly compatible environment, the invention may be embodied in a system and method operating in a downwardly incompatible environment. Although the system is being described as occurring on a single site, one skilled in the art will recognize that the system may be provided by an integral site or multiple sites. Further, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A computer-based method, comprising the steps of:
receiving an indication of a web document to inspect;
receiving an indication of a browser package having a set of versions containing at least one version;
retrieving from memory a first set of keywords corresponding to a computer language not executable by the browser package; and
determining based on the first set of keywords whether the web document is incompatible with the browser package.

2. The method of claim 1, wherein the step of receiving an indication of a web document includes receiving input from a user.

3. The method of claim 1, wherein the step of receiving an indication of a browser package includes receiving input from a user.

4. The method of claim 1, wherein the browser package includes one browser package from a set of browser packages.

5. The method of claim 4, wherein the first set of keywords is determined by compiling keywords corresponding to the computer language executable by the browser packages in the set of browser packages other than the keywords corresponding to the computer language executable by the one browser package.

6. The method of claim 1, wherein the keywords include keywords corresponding to script operations not executable by the browser package.

7. The method of claim 1, wherein the browser package includes Netscape.

8. The method of claim 1, wherein the browser package includes Explorer.

9. The method of claim 4, wherein the set of browser packages includes Netscape and Explorer.

10. The method of claim 1, further comprising the step of, if no keywords from the first set are located in the web document, then assuming that the web document is compatible with at least one version from the set of versions.

11. The method of claim 1, wherein the browser package includes downwardly compatible versions, further comprising the step of, if no keywords from the first set are located in the web document, then determining that the web document is compatible with at least one version from the set of versions.

12. The method of claim 1, further comprising the steps of
retrieving from memory a second set of keywords corresponding to computer language not executable by at least one of the set of versions;
parsing the web document for the second set of keywords; and
determining, if at least one keyword from the second set is located in the web document, that the web document is incompatible with the at least one of the set of versions.

13. The method of claim 12,
wherein the set of versions are downwardly compatible;
further comprising the step of determining, if at least one keyword from the second set is located, that the web document is incompatible with the at least one of the set of versions and all earlier versions in the set of versions.

14. The method of claim 12, further comprising the step of determining, if no keywords from the second set are located, that the web document is compatible with the at least one of the set of versions.

15. The method of claim 14,
wherein the set of versions are downwardly compatible;
further comprising the step of determining, if no keywords from the second set are located, that the web document is compatible with the at least one of the set of versions and all later versions.

16. The method of claim 1, further comprising the step of parsing the web document for the first set of keywords.

17. A system comprising:
keyword memory storing a first set of keywords corresponding to computer language not executable by a browser package;
a search engine coupled to the keyword memory for searching a web document for keywords; and
an inspection engine coupled to the search engine for controlling the search engine to search the web document for the first set of keywords.

18. The system of claim 17, wherein the inspection engine receives input identifying the web document from a user.

19. The system of claim 17, wherein the inspection engine receives input identifying the browser package from a user.

20. The system of claim 17, wherein the browser package includes one browser package from a set of browser packages.

21. The system of claim 20, wherein the first set of keywords is determined by compiling keywords corresponding to the computer language executable by the browser packages in the set of browser packages other than the keywords corresponding to the computer language executable by the one browser package.

22. The system of claim 17, wherein the first set of keywords includes keywords corresponding to script operations not executable by the browser package.

23. The system of claim 17, wherein the browser package includes Netscape.

24. The system of claim 17, wherein the browser package includes Explorer.

25. The system of claim 20, wherein the set of browser packages includes Netscape and Explorer.

26. The system of claim 17, wherein
a browser package contains a set of versions containing at least one version; and
the inspection engine assumes, if no keywords from the first set are located in the web document, that the web document is compatible with at least one version from the set of versions.

27. The system of claim 17, wherein
the browser package contains a set of downwardly compatible versions; and
the inspection engine determines, if no keywords from the first set are located in the web document, that the web document is compatible with at least one version from the set of downwardly compatible versions.

28. The system of claim 26, wherein the inspection engine
retrieves from memory a second set of keywords corresponding to computer language not executable by at least one of the set of at least one version;
controls the search engine to search the web document for the second set of keywords; and
determines, if at least one keyword from the second set is located in the web document, that the web document is incompatible with the at least one of the set of versions.

29. The system of claim 28, wherein
the set of versions includes a set of downwardly compatible versions; and
the inspection engine determines, if at least one keyword from the second set is located, that the web document is incompatible with the at least one of the set of downwardly compatible versions and all earlier versions in the set of downwardly compatible versions.

30. The system of claim 28, wherein the inspection engine determines, if no keywords from the second set are located, that the web document is compatible with the at least one of the set of versions.

31. The system of claim 29, wherein
the set of versions include a set of downwardly compatible versions;
the inspection engine determines, if no keywords from the second set are located, that the web document is compatible with the at least one of the set of downwardly compatible versions and all later versions.

32. A system comprising:
means for receiving an indication of a web document to inspect;
means for receiving an indication of a browser package having a set of versions containing at least one version;
means for retrieving from memory a first set of keywords corresponding to a computer language not executable by the browser package; and
means for determining based on the first set of keywords whether the web document is incompatible with the browser package.

33. A computer-readable storage medium storing program code for causing a computer to perform the steps of:
receiving an indication of a web document to inspect;
receiving an indication of a browser package having a set of versions containing at least one version;
retrieving from memory a first set of keywords corresponding to a computer language not executable by the browser package; and
determining based on the first set of keywords whether the web document is incompatible with the browser package.

34. A computer-based method, comprising the steps of:
receiving an indication of a web document to inspect;
receiving an indication of a browser package containing a set of versions;
retrieving from memory a set of keywords corresponding to computer language not executable by at least one version of the set of versions; and
determining, if a keyword from the set of keywords is located in the web document, that the web document is incompatible with the at least one version of the set of versions.

35. The method of claim 34, further comprising the step of assuming, if no keywords from the set of keywords are located in the web document, that the web document is compatible with at least one version from the set of versions.

36. The method of claim 34,
wherein the set of versions are downwardly compatible;
further comprising the step of determining, if no keywords from the set of keywords are located in the web document, that the web document is compatible with at least one version from the set of versions.

37. The method of claim 36, further comprising the step of determining, if at least one keyword from the set of keywords is located, that the web document is incompatible with the at least one of the set of versions and all earlier versions in the set of versions.

38. The method of claim 36, further comprising the step of determining, if no keywords from the set of keywords are located, that the web document is compatible with the at least one of the set of versions and all later versions.

39. A system, comprising:
keyword memory storing a set of keywords corresponding to a computer language not executable by a first version of a browser package containing a set of versions;
a search engine coupled to the keyword memory for searching a web document for keywords; and
an inspection engine coupled to the search engine for controlling the search engine to parse the web document for the set of keywords.

40. The system of claim 39, wherein the inspection engine assumes, if no keywords from the set of keywords are located in the web document, that the web document is compatible with the first version from the set of versions.

41. The system of claim 39, wherein
the set of versions are downwardly compatible;
the inspection engine determines, if no keywords from the set of keywords are located in the web document, that the web document is compatible with the first version from the set of versions.

42. The system of claim 41, wherein the inspection engine determines, if at least one keyword from the set of keywords is located in the web document, that the web document is incompatible with the first version and all earlier versions in the set of versions.

42. The system of claim 40, wherein the inspection engine determines, if no keywords from the set of keywords are located, that the web document is compatible with the first version and all later versions.
